(19) United States
(12) Patent Application Publication
(10) Pub. No.: US 2022/0356376 A1
(43) Pub. Date: Nov. 10, 2022

(54) HEAT-ACTIVATED ADHESIVE PATCH WITH INTEGRAL ATTACHMENT DEVICE AND METHOD FOR MAKING SAME

(71) Applicants: Gregory John Wenkman, Naples, FL (US); William Scott Wenkman, Phoenix, AZ (US)

(72) Inventors: Gregory John Wenkman, Naples, FL (US); William Scott Wenkman, Phoenix, AZ (US)

(73) Assignee: American Braqnds, LLC, Phoenix, AZ (US)

(21) Appl. No.: 17/315,280

(22) Filed: May 8, 2021

(51) Int. Cl. C09J 7/35; C09J 7/38; C09J 7/29; C09J 7/21; C09J 7/25; C09J 7/24

(52) U.S. Cl. CPC C09J 7/35; C09J 7/38; C09J 7/29; C09J 7/21; C09J 7/255; C09J 7/245; C09J 7/243; C09J 2477/006; C09J 2467/006; C09J 2433/006; C09J 2427/006; C09J 2423/106; C09J 2423/046; C09J 2400/263; C09J 2301/208; C09J 2301/122

(57) ABSTRACT

The present invention is directed to a heat-activated adhesive patch with integral attachment device wherein said patch can be permanently attached to an article of clothing or other article made of natural or synthetic substrate by means of using heat and pressure, whereby said patch with integral attachment device can be used to attach or hang an article or device from said heat-activated patch using said integral attachment device.

### FIELD OF INVENTION

The present invention relates to heat-activated adhesive patches that can be used as a functional patch and or as an embellished patch that can be adhered to an article of clothing or other article made of natural or synthetic substrate.

### BACKGROUND OF THE INVENTION

When referring to patches used on articles of clothing, such as shirts, pants, hats, backpacks, and the like, prior art reveals two general types of patches, those being: (1) a patch of fabric or other substrate material used to make a repair on a damaged article such as clothing where a patch is used to cover the damaged area, or (2) a patch, which is commonly referred to as a decorative or embellished appliqué, badge, emblem, or patch that is usually made from one or more pieces of fabric or substrate material that is woven or non-woven to include an insignia, or design displaying an image on a woven or non-woven, or embroidered patch using different colored threads. A more recent type of patch is one that is decorated using the technique of dye-sublimation printing.

Embellished embroidered patches or decorated woven patches or decorated printed patches are used in hundreds of uses to identify company logos, insignias, trademarks, people's names, titles, company services and department, characters, numbers, military grades, sayings and or designs; their uses are endless as an insignia or design to display an image and nothing more.

Either of the two types of patches mentioned above can be sewn on to the article of clothing, but in the last few decades patches can be purchased with a heat-activated thermoplastic adhesive backing that can be quickly adhered to an article of clothing, or other substrate, by the consumer using an ordinary household iron, or the shirt modifier using a standard heat press, to apply heat and pressure to bond the patch permanently to an article of clothing by melting the heat-activated thermoplastic adhesive sufficiently to bond together the patch to an article of clothing or other substrate.

More and more people in the last few decades have gone away from sewing, including sewing on patches since it is quicker and easier to iron on a patch than to sew it on an article of clothing. Men in general prefer to iron clothing as opposed to sew clothing.

The patch manufacturer can add an additional layer of adhesive, called a pressure-sensitive adhesive layer, with a release liner, to the patch over the heat-activated adhesive to aid the consumer to properly align, position, and temporarily retain the patch onto the article of clothing before permanently heat bonding the patch to the article of clothing using a household iron, or the like. The release liner must first be removed from the pressure-sensitive adhesive substrate before final application.

Prior art does not reveal a heat-activated adhesive patch that includes an integral attachment device whereafter applying the heat-activated adhesive patch to an article of clothing or other article made of natural or synthetic fabric or substrate the patch with an integral attachment device can be used to attach and or hang an article or device to the patch utilizing the integral attachment device.

There are many articles or devices that are attached to an article of clothing by the consumer, such as a clear plastic name cardholder with a safety pin attached, a campaign button, a temporary-use badge, to mention a few. All require an attachment device, such as the safety pin device which punctures the clothing article such as a shirt and the location of placement may be randomly chosen where a predetermined location may be desired or required by an authority of the patch provider.

Should the consumer or wearer want to attach an article or device to a shirt or pants there are numerous devices known in the art such as male and female button snap that requires the purchase of a metal punch and anvil for its assembly, or a button and button hole flap that requires the skill of sewing and the purchase of thread and needle.

The applicant-inventor recently, under application Ser. No. 16/943,854, applied for an utility patent relating to his claimed invention entitled: Shirt with hold-down suspender devices and suspender attachment devices and shirt hold-down suspender devices. The claimed invention relates to a suspender device that is designed to be attached to the inside of the shirt to hold-down the wearer's shirt onto the wearer's upper body while the wearer is in motion as that of a wearer/rider of a motorcycle.

The claimed invention in application Ser. No. 16/943,854 further relates to a shirt manufactured or modified to include suspender attachment devices that are or can be attached to the inside of the shirt, permanently or temporarily, to allow attachment of the suspender device to the suspender attachment device. The manufacturer or modifier of the shirt can easily add, by means of sewing or ultrasonically welding, these suspender attachment devices to the inside of the shirt, but the consumer cannot easily install the suspender device to an unmodified shirt that does not have the suspender attachment device, which are nearly all existing shirts.

Therefore, the consumer that wishes to incorporate the shirt hold-down suspender devices to an existing, or unmodified, shirt is confronted with having to first add the suspender attachment devices to his shirt. The consumer is left with the decision on how best to attach the suspender attachment devices, which may consists of a small looped fabric-member that can receive a hook member to attach the suspender device, to his existing or unmodified shirt. This can be accomplished through a variety of methods which include: attaching a metal female and male buttons snap which require using special metal punch and anvil, or using a needle and thread to sew on a fabric suspender attachment device. These methods and others may not be desirable or acceptable to the consumer for user.

An alternative method provided by the present invention is for the consumer to attach a suspender attachment device using a heated-iron to iron-on a heat-activated adhesive patch or appliqué that contains an integral attachment device that once adhered to the inside of a shirt can quickly and easily allow attachment of a suspender device, as that shown in patent application Ser. No. 16/943,854, to the heat-activated patch with attachment device.

The applicant/inventor has invented, herein, a heat-activated patch, that may or may not be decorated with a design using different colored threads and or ink, that has an integral attachment device where the patch can be quickly adhered to an article of clothing, or other substrate, by using a household iron, or the like, and applying heat and pressure to melt the thermoplastic adhesive, or the like, into the fabric of the clothing to form a permanent bond between said patch and the fabric or other substrate. Whereafter another article or device, such as the suspender device with a hook shown in the inventor's application Ser. No. 16/943,854 can be hung from said patch by utilizing said integral attachment device consisting of integral looped hanger device.

There are numerous other applications for the present invention, that may consist of decorated printed heat-activated adhesive, woven or embroidered, patch, or the like, each with an integral attachment device where another article or device can be attached to or hung from said integral attachment device.

### BRIEF SUMMARY OF THE INVENTION

It is, therefore, an object of the present invention to provide a heat-activated adhesive patch that includes an integral attachment device where another article or device can be attached to or hung from said heat-activated adhesive patch utilizing said integral attachment device which is formed from an extended integral tail member from the main body of said patch wherein a least a portion of the integral tail member is looped back onto itself and or the main body of said patch and is adhered to the back side of said patch, by the consumer or manufacturer, using the existing heat-activated adhesive on, at least a portion of, the back side of the patch to create a looped member from which another article or device can be hung from.

It is another object of the present invention to provide a heat-activated adhesive patch with integral attachment device that can employ the technique known as weaving and embroidering to embellish said patch with a design, graphics, or other indicia, on said patch using colored thread.

It is another object of the present invention to provide an easy means to adhere an attachment device to an article of clothing from which to hang another article or device from without the necessity of having to sew the attachment device to the article of clothing.

It is another object of the present invention to provide a heat-activated adhesive patch with integral attachment device where said integral attachment device is reinforced with a second layer of substrate designed to reinforce and strengthen said integral attachment device.

It is another object of the present invention to provide a means to hang another article or device to a heat-activated patch that has been applied to an article of clothing without the need to use another fastening or attachment device to a patch.

It is another object of the present invention to provide a heat-activated patch with graphics or design from which to hang an article or device from said patch that can combine related information or graphics on the patch with printed woven graphics on tag or label graphics to be hung from said patch.

It is another object of the present invention to provide a heat-activated patch with an integral attachment device where an article or device can be hung from said patch adhered to the inside of a shirt, concealed from view of others, like: a suspender, a wallet or money pouch, a knife holder, a deodorant pad, a flask, a medicine or medicinal pouch.

It is another object of the present invention to provide a heat-activated patch with an integral attachment device that can be adhered just above the hem of the pants legs, such as jeans, to be able to hang an elastic suspender device that has a hook at each end to said patch to hold-down the pants legs while the wearer is riding a motorcycle.

It is another object of the present invention to provide a quick and easy means to attach a hanging device, using said patch, from the inside of a shirt to be able to hang a suspender device that connects the wearer's shirt to the wearer's pants to be able to hold-down the shirt on the wearer's upper body while the wearer is in motion as that of a wearer riding a motorcycle.

It is another object of the present invention to provide a heat-activated adhesive patch with an integral attachment device that has a button slot in said integral attachment device that can accommodate a plastic or metal double sided button separated by a small integral shaft whereby said button can be inserted into said slot an additional article or device can be attached to or hung from said integral attachment device employing said double sided button.

### BRIEF DESCRIPTION OF THE DRAWINGS

Other objects, features, and advantages of the present invention will become more apparent from the following detailed description of the preferred embodiments and certain modifications thereof when taken together with the accompanying drawings, which are but a few examples of the present invention.

FIG. 1 is a front elevation of patch 1 showing the front side 2 with a circular main body 3 and an integral tail-member 4 with a border 5.

FIG. 2 is a back elevation of patch 1 showing the back side 6 coated with at least one layer heat-activated adhesive 7 shown by diagonal lines and free of any heat-activate adhesive coating area 8 shown without diagonal lines.

FIG. 3 is a back elevation of patch 1 where a portion of integral tail-member 4 has been folded back upon the main body 3 where heat-activated adhesive 7 is present on the back side 6 of the main body 3 and the back side 6 of the integral tail-member 10 shown by opposite diagonal lines where integral attachment device 9 has been formed to create an opened integral looped-device 9 without adhesive to be known as the integral attachment device.

FIG. 4 is a side elevation of patch 1 showing side 11, with the front side 2 is facing to the right and the back side 6 is facing to the left, with a portion of integral tail-member 4 is folded back 180 degrees and is contacting the main body 3 at 10 creating the integral attachment device 9 or an opened integral looped-device 9 where another article or device can be attached to or hung from and where it is free of adhesive in area 8 while the tail-member 4 has adhesive at area 10 that when contacting main body 2 that has adhesive 7 and where the manufacturer or the consumer using heat an pressure adheres the tail-member portion to the main body 3, that can also include a portion of the tail 4 if covered with adhesive 7. Finished patch 42 represents patch 1 as a finished heat-activated patch with integral attachment device ready to be adhered by the consumer or shirt modifier to an article of clothing or other substrate.

FIG. 5 is a back elevation of another form of patch 1 showing the border 5 of back side 6 where 100% is covered with heat-activated adhesive 7 shown by the diagonal lines 7.

FIG. 6 is a front elevation of substrate insert member 12 that has a front side 13 and a back side 14 where at least side 13 is free of adhesive.

FIG. 7 is a back elevation patch 1 where substrate insert 12 is laid onto integral tail-member 4 just below main body 3 wherein the backside 14 of insert 12 comes in contact with heat-activated adhesive 7 on tail-member 4 in the area 15 where insert 12 is free of any adhesive on the front side 13.

FIG. 8 is a back elevation of patch 1 showing the integral tail-member 4 is folded over 180 degrees to create integral attachment device 9 or looped tail 9 and once tail member portion 10 is heat sealed to main body 3 the integral attachment device 9 has been created, and where insert member 12 to adhered to the tail 4.

FIG. 9 is a side elevation of patch 1, in its finished form 43, with the front side 2 facing to the right, the back side 6 facing to the left where the integral tail-member 4 is folded over 180 degrees creating integral attachment device 9 or integral looped-member 9 from which an article or device can be hung from and which includes insert member 12 where front side 2 maybe be embellished with graphics 16 from colored threads and or colored ink.

FIG. 10a is a front elevation of patch 1, in its finished form as a woven patch 43 with a laser or die cut edge 5 the front side 2 that has graphics 16 consisting of colored threads 16 and a light dashed line 22 representing a see-through area where a portion of tail-member 4 is adhered by utilizing the heat activated glue on the back side 6. Hook 17 connected to strap 18, can be attached to and hung from integral attachment device 9 of finished heat-activated adhesive patch 43 and has an insert substrate member 12 free of adhesive on the open side for reinforcing open looped-member 9. FIG. 10b is a front elevation of patch 1, in its finished form as a woven patch 42 with colored threads making the graphic design 16 with open looped member 9 where split ring 40 is attached to and hung from integral attachment device 9 while hook 41 which is connected to strap 18 is attached to split ring 40. FIG. 10c is a front elevation of patch 1, in its finished form as a woven patch 42 with colored threads making the graphic design 16 with open looped member 9 as the integral attachment device 9 where plastic female snap connector 53 can be snapped onto plastic male snap connector 54 which is attached to strap 18.

FIG. 11 is a front/side elevation of pants 19 and boot 23 with finished patch 43 adhered to pants 19 where suspender strap 25 with hook 24 is attached to and hung from integral attachment device 9 of finished patch 43.

FIG. 12 is a back elevation of patch 1 as shown by the patch border 5 showing back side 6 with main body 3 and integral tail-member 4 covered with heat-activated adhesive 7 shown by the diagonal lines 7.

FIG. 13 is a front elevation of fabric insert member 27 that has a front side 28 and a back side 29.

FIG. 14 is a back elevation of patch 1 where fabric insert member 27 has been laid onto patch tail-member 4 with the back side 29, that may or may not be covered with pressure sensitive adhesive on back side 29, to be laid upon an area of heat-activated adhesive 7 shown by the dashed-diagonal lines on tail-member 4 with the front side 28 of insert member 27 facing up on the back side 6 of patch 1.

FIG. 15 is a front elevation of patch 1 where integral tail-member 4 has been flipped over 180 degrees onto the back side 6 of the main body 3 where the back side 6 of the tail-member 4 and the face of main body 3 contact with each other and both have heat-activated adhesive 7 where the tail-member 4 has been wrapped around entrapping fabric insert member 27, creating integral looped-member 9 when heat and pressure have been applied to adhere the heat-activated adhesive faces 7 together from which an article or device can be hung from integral attachment device 9 which is free of heat activated adhesive 7 inside of said loop.

FIG. 16 is a side elevation of patch 1 where it is in finished form 44 where the front side 2 faces to the right and the back side 6 faces to the left, where tail-member 4 has been folded back 180 degrees an attached to the back side 6 of the main body 3 of patch 1 entrapping fabric insert member 27 creating integral attachment device 9 or integral looped-member 9.

FIG. 17 is a back elevation of patch 1 and in its final configuration 44 and suspender device 36 that has an elongated strap 31 which by inserting the hook 29 with an opening 30 into the integral attachment device 9 or the looped-member 9 suspender device 36 can be attached to and hung from patch 44 which can be attached to the inside of a shirt where the opposite end of the suspender device 36 can be attached using hook 37 that has an opening 38 to a pants belt loop 39 on the wearer's pants to connect the wearer's shirt to the wearer's pants to hold down the wear's shirt that is worn outside the wearer's pants when riding a motorcycle.

FIG. 18 is a front elevation of a sheet of woven fabric 45 or felt substrate 45, free of adhesive, with heat-activated adhesive applied to the backside 53 (not shown) from which the heat-activated adhesive patch 46 with an integral tail member 50 is laser or die cut from sheet 45 where extended flap substrate member 48 can be folded 180 degrees and laid upon tail member portion 51.

FIG. 19 is a back elevation of heat-activated adhesive patch 46 that has an integral extended tail member 50 with an additional extended flap member 48 that can be folded over an adhered to tail member portion 51.

FIG. 20 is a back elevation of heat-activated adhesive patch 46 where extended flap member 48 has been folded over 180 degrees and laid upon area 51 of tail member 50.

FIG. 21 is a back elevation of final form of heat-activated adhesive patch 46 where extended tail member 4 has been folded over 180 degrees and laid upon and adhered to the backside of patch 1 where the extended tail 4 has been reinforced at area 51 after extended tail member portion 48 has been folded over and laid upon area 51 of tail member 4 creating integral attachment device 9 or open loop attachment device 9.

FIG. 22 is a side elevation of heat-activated adhesive patch 46 wherein its final form 52 is shown where a portion of tail member 4 is adhered to the patch main body 3 using the heat-activated adhesive 7 on the surfaces of the tail member 4 and the main body 3 adhesive 7. where an integral attachment device 9 has been formed to have a double layer 51 of the substrate.

FIG. 23 is a front elevation of heat-activated adhesive patch 58, that has a front side 54, a border 53, an integral tail member 55, button slot 56, a second button slot 56a and a mark 57 that locates the folding point of tail member 55.

FIG. 24 is a rear elevation of heat-activated adhesive patch 58, the heat-activated adhesive is represented by dashed line 59.

FIG. 25 is a rear elevation of heat-activated patch 58, where the tail-member 55 has been folded back 180 degree at the notch or fold-mark area 57 where the back side of the lower portion of the tail member 55 layered with heat-activated adhesive 59 is facing the upper portion of the back side of the tail member 55 layered with heat-activated adhesive 59, so that when heat and pressure is applied to the folded tail member 55, including the tail member 55, the tail member 55 is formed into the integral attachment device is adhered together using heat-activated adhesive surface 59 and formed to make one reinforced button slot 63 utilizing button slot 56 and 56a on extended integral tail member 55.

FIG. 26 is the same view of FIG. 25 with the addition of a plastic or metal double faced button 60 that has been inserted into the single button slot 63 (shown in FIG. 25) that has been formed from buttons slots 56 and 56a that are laser cut or die cut into extended integral tail member 55 as shown in FIG. 23. and where an elongated strap member 61 with buttons slots 62 can be attached to or hung from said button 60 utilizing said integral attachment device 55.

FIG. 27 is a side elevation of heat-activated adhesive patch 58 where the front side 54 faces right and the back side 59 faces left where a plastic or metal button 60 is inserted into slot 63 which another article or device can be attached to or hung from said button 60 utilizing the integral attachment device 55. Elongated strap member 61 with button holes 62 can be attached to and hung from said button 60 utilizing said heat-activated adhesive patch 58 with integral attachment device 55.

FIG. 28. is a front elevation of heat activated adhesive patch 64 with the front side 65, with a border 66 and an extended integral tail-member 67 a laser or die cut hole 68 and a second hole 68a and a laser or die cut folding mark 69.

FIG. 29 is a rear elevation 70 of the heat-activated adhesive patch 64 coated with at least one coat of heat activated adhesive represented by diagonal lines 70.

FIG. 30 is a rear elevation 70 of patch 64 where the extended integral tail-member 67 has been folded over 180 degrees at the laser or die cut fold-mark 69 where the back side of the lower portion of the tail member 67 is facing the upper portion of the back side of the tail member 67, so that when heat and pressure is applied to the extended integral tail-member 67, the integral attachment device 78 is adhered using heat-activated adhesive surface 70 and formed to make one reinforced tail member 72 with one uniform hanger hole 71 to form integral attachment device 78.

FIG. 31 is a front elevation 65 of patch 64 where the patch has an insignia 76 and a hook 73 hanging from the integral attachment device 78 at hole 71 where there is shown an I.D. insignia 75 is printed on security card 74 which is hung from hook 73 using hole 77, which shows an article or device 73/74 being hung from heat-activated adhesive patch with integral attachment device 79.

### DETAILED DESCRIPTION OF THE INVENTION

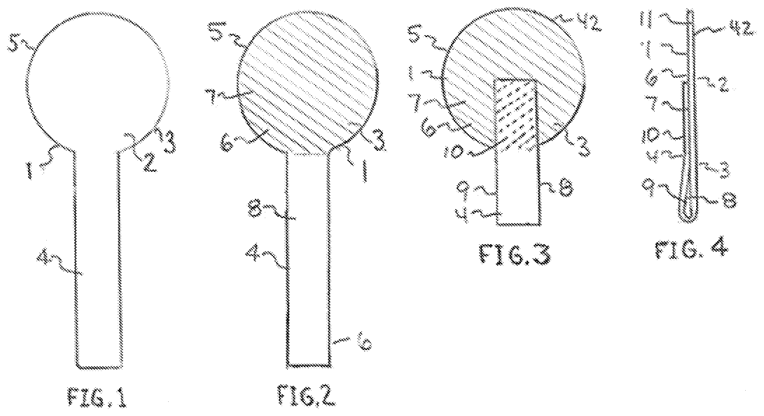

With reference to FIG. 1-4 a patch 1 having a front side 2 and a back side 3 with a border 5 that can be any size or shape comprising a border 5 providing it includes an integral tail member 4, of any design or shape, that after a heat-activated adhesive 7 is applied to at least a portion of the back side 3 as shown in FIG. 2 by diagonal lines to represent heat-activated adhesive 7 (and or a portion of back side of tail member 4 not shown) and the patch 1 is thereafter die cut, laser cut, or cut by other means, from a sheet or web of substrate, at border 5 the integral tail member 4 can be folded back upon at least a portion of the main body 3 and or a portion of the integral tail member 4 to form a sealed open integral loop that is herein referred to as an integral attachment device 9, once heat and pressure has been applied to activate the adhesive 7 present on the back side 3, and or tail member 4, of said patch 1 to adhere at least a portion of the extended tail member 4 to itself and or the back side 3 of said patch 1 to form an integral attachment device 9 from which an article or device can be attached to or hung from said final form heat-activated adhesive patch 42 as shown in FIG. 4. that is made any of the following: a natural or synthetic material such as: cotton, denim, silk, wool, leather, hemp, jute, nylon, acetate, acrylic, rayon, polyester, polypropylene, polyethylene, polyolefin, felt, or any combination thereof.

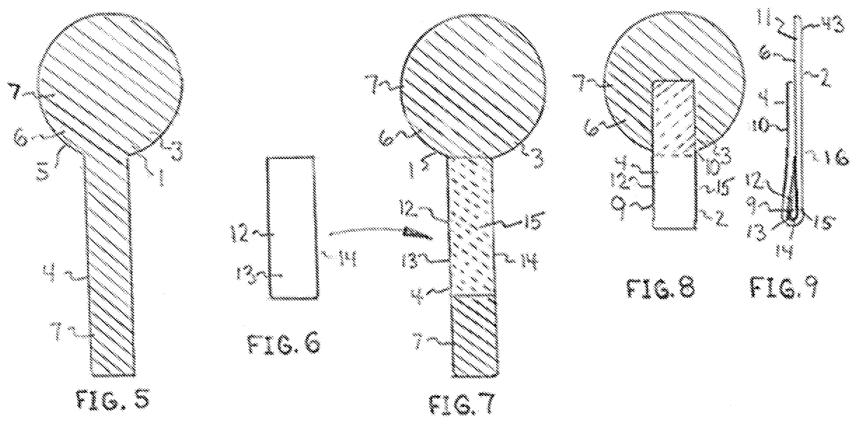

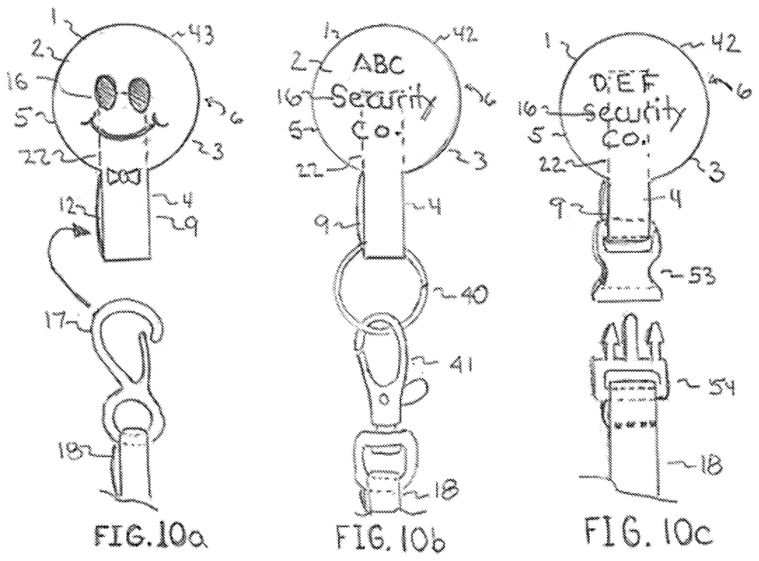

With reference to FIG. 5-9 differs little from FIG. 1-4. Here the entire back side 6 is coated with at least one coating of heat-activated adhesive 7 as represented by diagonal lines. An addition of an insert fabric-member 12 or insert substrate-member 12, which may or may not have pressure-sensitive adhesive applied to one side, being placed upon the tail-member 4 in FIG. 7 in the approximate area 15 of patch 1. The insert substrate-member 12, having a front side 13 and a back side 14, which is added to strengthen the integral attachment device 9, as shown in FIG. 8 and cover the area which has heat-activated adhesive 7, and can be made of natural or synthetic material consisting of cotton, denim, silk, wool, leather, hemp, jute, nylon, acetate, acrylic, rayon, polyester, polypropylene, polyethylene, polyolefin, mylar or any combination thereof. In FIG. 8 a portion of tail member 4 has been folded over 180 degrees to form extended looped member 9 herein called an integral attachment device 9 where the bottom area of the tail member 4 coated with heat-activated adhesives 7 faces the back side 6 that also has at least one layer of heat-activated adhesive. Using heat and pressure the portion of the tail member 4 and the portion of the back side of the main body 3 of the patch 1 adhere together permanently creating the integral attachment device 9 as shown in FIG. 8 and FIG. 9 where the tail member portion 15 is free of heat activated adhesive 7 creating an integral attachment device 9. Finished patch 43 is ready for application by the user.

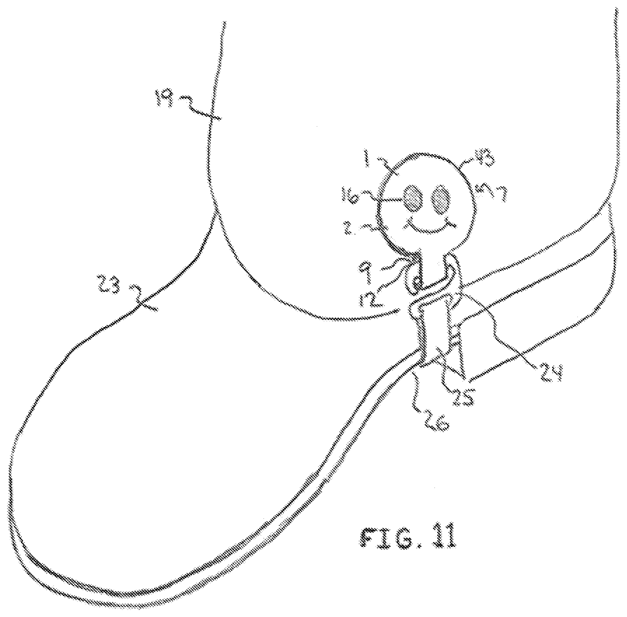

With reference to FIGS. 10a, 10b, and 10c shows examples of finished patch 42 and 43 as a woven patch with colored threads making the graphic design 16 on the front side 2, but the graphic design 16 can also by done by embroidering or printing the design 16 and edge 5 is laser or die cut finish but can also have a Merrowed edge finish with integral attachment device 9 or opened looped fabric or substrate member 9 from which an article or device, such as plastic or metal hook 17 or a steel split ring 40 can be attached to and hung from the integral attachment device 9. The portion of the extended tail-member 4 that has been adhered to the back side of the main body 3 can be seen as a dashed outline 22 of the tail member 4 on the back side 6. FIG. 10b shows the hook 41 which is connected to a strap 18 is attached to a steel split ring 40 that has been attached to and hung from integral attachment device 9. FIG. 10a shows final form patch 43 to include the reinforcing member 12 that is part of integral attachment device 9 whereas FIG. 10b and FIG. 10c integral attachment device 9 is without the differ in that FIG. 10a shows that the integral attachment device 9 has an insert-member 12 to reinforced the integral attachment device 9 while FIG. 10b has no insert-member 12. Finish product 43 is shown in FIG. 10a while final form patch 42 shown in FIG. 10b. and FIG. 10c do not have the insert substate-member 12 in the integral attachment device 9.

With reference to FIG. 11 shows an example of the heat-activated adhesive patch 43, in use, with a design 16 wherein said patch 43 is adhered to a leg member of pants 19 of a wearer wearing boot 23, with a strap member 25 which is attached to and hung from integral attachment device 9 of patch 43 by means of hook 12 connected to strap member 25 which goes under boot 23 to be connected to a similar configuration on the opposite side of the wearer's pants' leg 19 and boot 23.

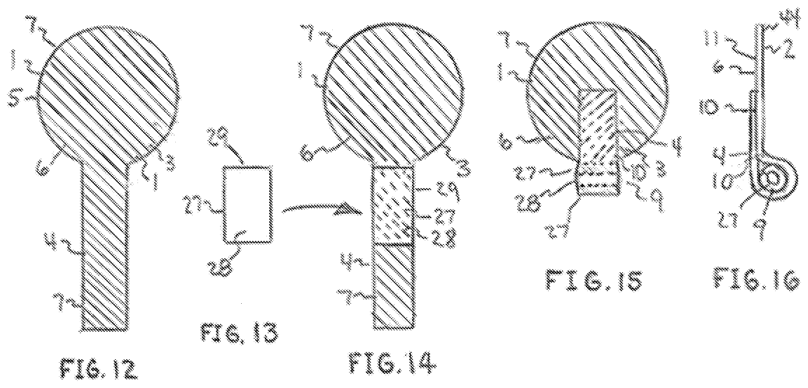

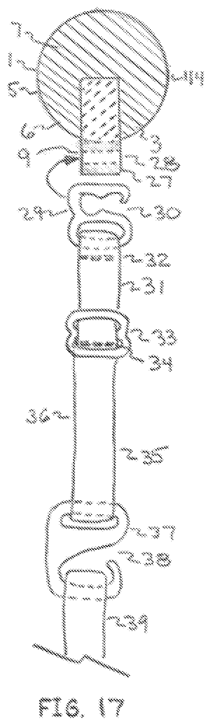

With reference to FIG. 12-16 shows an example of patch 1 to finished patch 44 which includes a fabric or substrate insert-member 27 having a front side 28 and a back side 29 that is made of natural or synthetic substrate material to reinforce integral attachment device 9 and help retain a hook device. Said insert member 27 may have pressure sensitive adhesive applied to side 28 or side 29 to help hold insert 27 in place while folding over extended tail member 4 over to heat seal to the backside 6 of patch 1. When heat and pressure is applied to the folded over extended tail member 4 onto the backside 6 the faces are bonded together because both faces have heat activated adhesive 7.

With reference to FIG. 17 shows finished heat-activated adhesive patch 44 where shirt-hold-down suspender device 36 (referenced in applicant's/inventor's patent application Ser. No. 16/943,854) can be attached to said patch 44 using hook 29 of said shirt hold-down device 36 which can be attached at the lower end using hook 37 to attach to the wearer's pants belt loop 39.

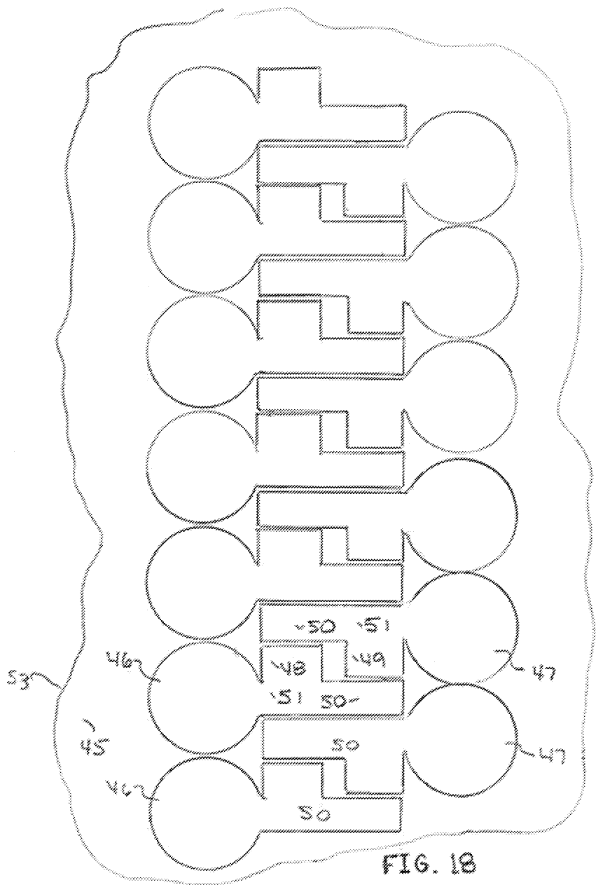

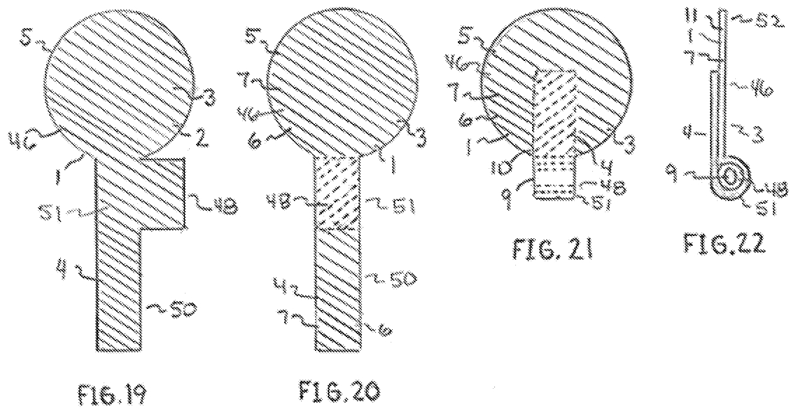

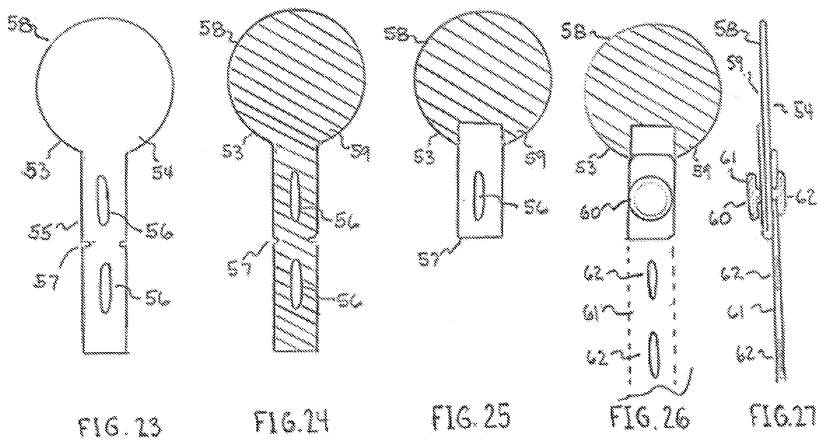

With reference to FIG. 18 shows substrate layer, sheet, or web material 53 made of woven or non-woven natural or synthetic material with heat-activated adhesive 45 (not shown with diagonal lines) on one side from which heat-activated adhesive patch 46 and 47 with integral tail member 50, can be efficiently produced with minimal waste, with reinforcing extended flap member 48 and reinforcing extended flap member 49 at no additional cost in the manufacturing process by the proposed layout configuration shown.

With reference to FIG. 19-22 shows yet another version of the invention, a heat-activated patch 46 with integral attachment device 9 where extended flap member 48 extending off the tail member 4 at the location 51 shown in FIG. 19. FIG. 20 shows extended flap member 48 has been folded over 180 degrees onto the tail member 4 covering the tail member area 51 of tail member 4 where both contacting faces have heat-activated adhesive 7. In FIG. 21 a portion of the tail member 4 has been fold over 180 degrees and adhered to the backside 6 of patch 46 creating and integral attachment device 9 which has an open looped member 9 that is free of adhesive 7 on the inside faces of the opened looped member 9 which is reinforced by having two layers by extended flap member 51 being adhered to tail member 4 at area 51 of substrate material to create final patch 52.

With reference to FIG. 23-27 shows yet another version of the invention, a heat-activated adhesive patch 58 with an extended integral tail member 55 that includes a pair of cut button slots 56 and 56a that when the extended tail member 55 is folded over at cut mark 57 and heat applied to said patch the adhesive 59 on the folded tail members 55 adheres together to form a reinforced integral attachment member 55 with a single button hole 63 where a double faced button 60 (integrally molded with a small core shaft between button heads) can be inserted into and retained by button slot 63 whereby an article or device can be attached to or hung from said integral attachment device 55 of said heat-activated patch 58 such as an elongated strap member 61 that has button slots 62.

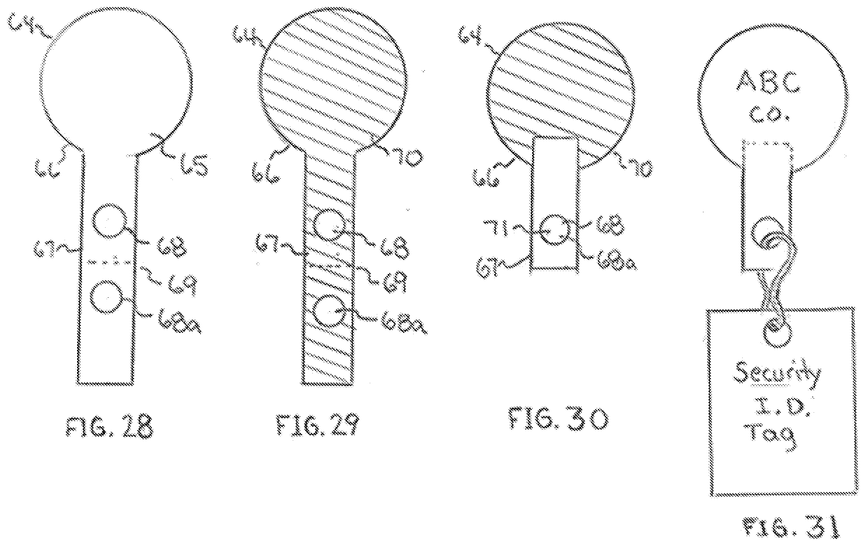

With reference to FIG. 28-31 shows yet another version of the invention, a heat-activated adhesive patch 64 with an border 66 and a front side 65 and an extended tail-member 67 with two holes 68 and 68a and a fold mark 69, with a back side 70 covered with heat-activated adhesive 70 (shown by diagonal lines), where FIG. 30 shows extended tail-member folded over 72 at mark 69 to form integral attachment device 78 with one uniform hole 70 while FIG. 31 shows final form of heat-activated adhesive patch with integral attachment device 78 in use with insignia 76 on front side 65 with hook 73 hanging from integral attachment device 78 at hole 71 with I.D. card 74 with insignia 75 hanging by hole 77.

The present patent application herein shows patches that consists of patches that have a circular body with an extended integral tail-member that is used to form a closed looped hanging device, herein referred to as an “integral attachment device”. It should be understood that the present invention encompasses any an all design configurations in shape and size of a heat activate adhesive patches with an integral attachment device wherein another article or device can be attached to or hung from said integral attachment device.

While the invention has been described with reference to a particular embodiment and method therefor, it is apparent that many other embodiments and methods would be obvious to those skilled in the arts in view of the foregoing specification, thus the scope of the claims should not be limited by the detailed foregoing description, but rather only by the scope of the claims annexed hereto.

Also, the phraseology and terminology used herein is for the purpose of description and should not be regarded as limiting. Any references to embodiments or elements or acts of the systems and methods herein referred to in the singular may also embrace embodiments including a plurality of these elements, and any references in plural to any embodiment or element or act herein may also embrace embodiments including only a single element. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

When the words “permanent or permanently” are used herein regarding heat-activated adhesive patches it is to be understood that it is meant for permanent installation and not for temporary installation, however, over extend time the patch may loosen from the article of clothing to which it has been adhered too. Nothing in reality is truly permanent.

What is claimed is:

1. A heat-activated adhesive patch with integral attachment device that can be permanently attached to an article of clothing or other article made of natural or synthetic substrate by means of using heat and pressure whereby said patch with integral attachment device can be used to attach an article or device to said patch utilizing said integral attachment device which comprises an extended integral tail-member of said patch which can be folded, at least once, back upon itself and or a portion of the main body of said patch wherein said integral tail-member can be adhered by a manufacturer, installer, or consumer using the heated-activated adhesive on said patch therein creating an integral looped hanger member, herein called an integral attachment device, from which an article or device can be attached to or hung from said integral attachment device of said heat-activated adhesive patch.

2. A heat-activated adhesive patch with integral attachment device as in claim 1 wherein said patch, at least in part, is made of natural or synthetic substrate from any one or more of the following materials: cotton, denim, silk, wool, leather, hemp, jute, nylon, acetate, acrylic, polyvinyl chloride (PVC), rayon, polyester, polypropylene, polyethylene, polyolefin, felt, woven patch, thread.

3. A heat-activated adhesive patch with integral attachment device as in claim 1 wherein patch substrate has a front-side and a back-side where the back-side of the patch substrate has been coated, at least in part, with at least one layer of heat-activated thermoplastic adhesive.

4. A heat-activated adhesive patch with integral attachment device as in claim 1 wherein said patch is made of or from: printed-fabric, woven-fabric, non-woven fabric, embroidered fabric, and or substrate decorated, at least partially, to include on the front side of said patch a design, such as a: logo, advertising, trademark, company name, person's name, person's title, quote, words and or numbers, or the like using colored thread and or colored ink.

5. A heat-activated adhesive patch with integral attachment device as in claim 3 wherein said patch with integral attachment device can be ironed on a shirt, or another article of clothing, using a heated household iron or heat press whereafter doing so an article or device can be attached to or hung from said patch utilizing a looped extended integral tail-member; herein called integral attachment device of said patch.

6. A heat-activated adhesive patch as in claim 1, wherein said patch with an integral attachment device is a made from one piece of fabric or substrate material in any size or configuration to form said patch with an extended integral tail-member which can be folded over and heat sealed, using the heat-activated adhesive on said patch, upon itself and or a portion of the main body of said patch wherein the folded integral tail-member device, herein called integral attachment device, forms an integral tail member with at least one: open loop, and or closed loop, and or slot, and or hole, and or opening from which to attach or hang another article to said integral attachment device of said patch.

7. A heat-activated adhesive patch with integral attachment device as in claim 1 wherein said patch has over the layer of heat-activated adhesive a layer of pressure-sensitive adhesive, at least partially with a release liner, covering the pressure-sensitive adhesive coating whereby said pressure sensitive adhesive is intended to aid the consumer or user in temporarily aligning and or holding said patch in place before permanently adhering said patch to another substrate using said heat-activated adhesive.

8. A heat-activated adhesive patch with integral attachment device as in claim 1 wherein said integral tail-member includes a second substrate-member that is laid upon at least a portion of the integral tail-member having a coating of heat-activated adhesive, before the integral tail-member has been folded over to form the integral attachment device to aid in improving strength of said looped-tail member by having the second-substrate member reinforce said integral attachment device.

9. A heat-activated adhesive patch with integral attachment device as in claim 1 wherein said extended integral tail-member includes a extended-member that is integral and that when said extended-member is folded over and onto said extended integral tail-member creates a second layer of substrate on the extended integral tail-member which when the extended integral tail-member is folded over onto itself and or main body of said patch reinforces said integral attachment device with said extended-member.

10. A heat-activated adhesive patch with integral attachment device as in claim 1 wherein said integral attachment device has two openings; slots, or button slots, or holes or slits, or the like, cut through said extended integral tail-member whereupon folding over said extended integral tail-member the two openings align together to form one uniform opening in the integral attachment device where at least one other article or device can be attached to said uniform open in said integral attachment device of said patch.

11. A method of making or manufacturing a heat-activated adhesive patch with an integral attachment device that can be permanently attached to an article of clothing or other article made of natural or synthetic material by means of using heat and pressure, where said patch with integral attachment device can be used to attach and or hang another article or device from said patch using said integral attachment device, where making of said patch comprises: (1) a substrate layer made of natural or synthetic material, selected from: denim, silk, wool, leather, hemp, jute, nylon, acetate, acrylic, rayon, polyester, polypropylene, polyethylene, polyolefin, felt or a combination thereof, (2) a substrate layer having a front side and a back side, (3) said back side is covered, at least in part, with at least one layer of heat-activated thermoplastic adhesive in the manufacturing process of said patch, and (4) at least one extended integral tail-member formed from and integral to said patch, where said extended integral tail-member is folded, or designed by the manufacturer to be folded, and looped back onto itself and or the main body of said patch and is, or will be, adhered to the back side of said patch by the manufacturer, consumer, or user using heat and pressure and using the existing heat-activated adhesive on the back side of said patch and or the back side of said integral extended substrate tail member to create an extended opened-looped and or closed-looped tail-member, herein called an integral attachment device, where another article or device can be attached to or hung from said heat-activated adhesive patch with integral attachment device.

12. A method of making or manufacturing a heat-activated adhesive patch with an integral attachment device as in claim 11 wherein the substrate layer is comprised of a woven patch or embroidered patch.

13. A method of making or manufacturing a heat-activated adhesive patch with an integral attachment device as in claim 11 wherein the substrate layer of said patch comprises colored thread and or colored ink.

14. A method of making or manufacturing a heat-activated adhesive patch with an integral attachment device as in claim 11 wherein the maker or manufacturer makes and sells said heat-activated adhesive patch with integral attachment device: (1) where the consumer or user of said patch folds the extended integral tail-member over to form the integral attachment device at time of final application of said heat-activated adhesive patch to an article of clothing or to other substrate, or (2) where the maker or manufacturer of said patch folds over the extended integral tail-member and using heat and pressure adheres to form said integral attachment device of said patch before sale of said device.
